(19) United States
(12) Patent Application Publication
(10) Pub. No.: US 2010/0225107 A1
(43) Pub. Date: Sep. 9, 2010

(54) Gas Tight Tubular Joint or Connection

(75) Inventor: Steinar Tverlid, Bjoroyhamn (NO)

Correspondence Address: Wenderroth Lind & Ponack, 2033 K Street NW, Suite 800, Washington, DC, 20006-1021, US

(73) Assignee: NORSK HYDRO ASA, Oslo (NO)

(21) Appl. No.: 12/223,988

(22) PCT Filed: Feb. 16, 2007
(86) PCT No.: PCT/NO2007/000058

§ 371 Date: Dec. 2, 2008

(30) Foreign Application Priority Data
Feb. 17, 2006 (NO) 20060790

(51) Int. Cl. F16L 13/00

(52) U.S. Cl. 285/286.2

(57) ABSTRACT

Gas tight tubular joint or connection, particularly related to mono diameter tubular body in the form of a pipe or casing being used in connection with the production of oil and/or gas, where the pipes or casings are manufactured from tubular sections and where the tubular sections, after being interconnected at their respective ends, are finally formed by expansion. The pipes or casings are formed from at least two, one outer and one inner tubular section. The ends of each of said respective section is overlapping the next, succeeding tubular section, whereby one or more of the inner, intermediate or outer tubular sections are of different metallic materials and/or different thickness, and under the deformation process, is plastified or plastically deformed in the overlapping zone forming a metallic seal and thereby providing gas pressure integrity between the inside and outside of the expanded tubular pipe/casing.

The present invention relates to a gas tight tubular joint or connection, particularly related to mono diameter pipe or casing being used in connection with the production of oil and/or gas, where the pipes or casings are manufactured from tubular sections and where the tubular sections, after being interconnected at their respective ends, are finally formed by expansion.

Expandable tubular casings have traditionally been used in the oil and gas industry to solve operational challenges met during the drilling and maintenance of wells. The technology covers applications such as:
Drilling liners—Expandable tubular used to case off a drilled section in a well. The expandable tubular is hung off in the previous casing or liner either prior to or after radially expanding the tubular. The result is a minimum or no loss in internal diameter in the wellbore. Expandable drilling liners are designed to endure the loads that the tubular casings may be exposed to during drilling, i.e. the mechanical loads during a gas kick situation.
Casing repair—Expandable tubular used to restore the mechanical integrity of mechanically damaged or eroded casings. By radially expanding the expandable tubular against the internal diameter of an existing damaged or eroded casing, the expandable tubular will replace the mechanical integrity that the original casing had before damage or erosion occurred. The interface between the expandable tubular and the original casing may be metal to metal with or without elastomer packing for fluid pressure integrity purposes
Cladding in open hole—Expandable tubular used to create a mechanical shield against unstable formations, i.e. mechanically weak formation or formation where fluid loss may occur

Expansion of a tubular is performed by inflicting stress to the material that forces the material from elastic deformation into plastic deformation. This permanently deforms the material to a pre-designed shape, i.e. radially deform a tubular by increasing the internal and external diameter. There are presently several expansion mechanisms for expanding metal tubular, including fixed cone, flexible cone and rotating expansion device driven by an axial mechanical force through the drillstring or by utilizing hydraulic power through the injected wellbore fluid, i.e. mud.

In the oil and gas industry there is a great expectation to the future applications of expandable tubular technology, aiming towards replacing the traditional nested casing design with a design that allows one internal diameter from top to bottom in a well. This future application is commonly referred to as “mono diameter” or “mono bore” and has potential to dramatically reduce field development cost, reduce environmental impact and increase safety within the drilling industry. The full potential may be revealed when achieving expandable tubular connections properties that satisfies production casing requirements, i.e. maintaining post-expansion gas pressure integrity.

A low gas pressure rating constitutes a limitation in the application of expandable tubular casings. When designing a well, different mechanical load scenarios are simulated to ensure mechanical integrity in the well during its full lifetime. A tubular casing with a relatively low gas pressure integrity may i.e. be used for drilling purposes but not be used as a fully qualified production casing, i.e. endure loads encountered if there is a leak in the production tubing allowing gas pressure against the production casing acting as a secondary barrier.

Challenges have been met with regard to achieving gas pressure integrity when using conventional connections between the expandable tubular joints, i.e. the threads dislocate and deform during the expansion process, reducing or eliminating interfacial residual stress, causing an absence of gas pressure integrity.

There exists several methods of joining expandable tubular, e.g. U.S. Pat. No. 6,409,175 and US patent application No. 2003/0234538.

U.S. Pat. No. 6,409,175 B1 relates to a method and apparatus are provided for obtaining a mechanical connection and pressure tight seal in the overlapping area of two telescoping tubular bodies where the two bodies are radially expanded and where the expansion forces an annular seal of Teflon in the overlapping area into a pressure sealing engagement between the bodies. Such seal is, however, not gas tight and accepted to be used in casings of well bores.

US patent application No. 2003/0234538 relates to a conventional threaded connection between segments expandable tubulars that provides multiple sealing points along the pin and box members that can withstand high pressures. This solution is neither gas tight.

The present invention relates to a gas tight expandable tubular joint or connection which overcomes the disadvantages with the known solutions and which is mechanically strong, potentially with metal sealing, and which is gas tight and complies with the requirements of casings in well bores. The joint or connection of an expandable tubular represents the weakest point of such tubular, and with the present invention is in particular obtained a lengthwise distribution of the connecting surfaces covering a larger area, thereby obtaining the increased local strength of the joint or connection.

The invention is characterized by the features as defined in the attached, independent claim 1.

Claims 2-5 define preferred embodiments of the invention.

The present invention will be described in further detail in the following by way of examples and with reference to the figures, where:

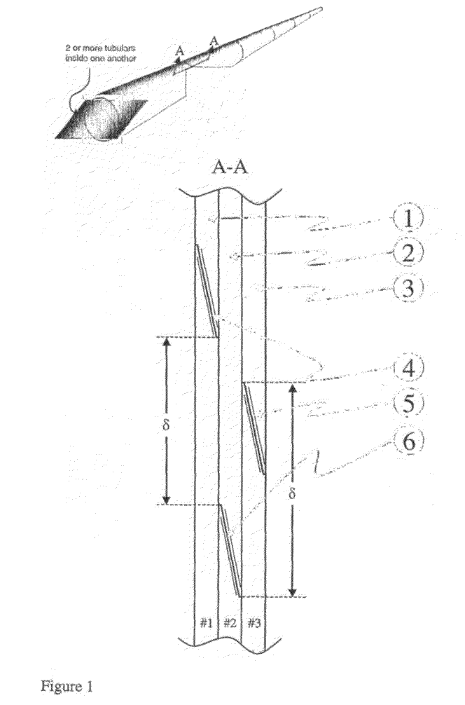

FIG. 1 shows a) in perspective a tubular body in the form of a pipe casing, and b) a cross section of a part of the tubular body along section line A-A in a) above,

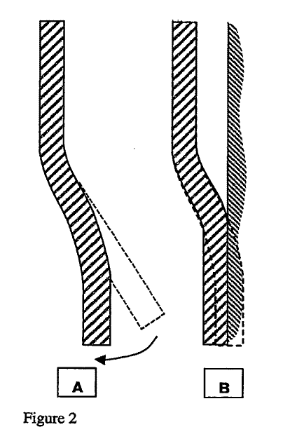

FIG. 2 shows a sketch illustrating one principle according to the present invention of obtaining residual compressive stresses on the interface between tubular sections inside one another, from which sealing is accomplished,

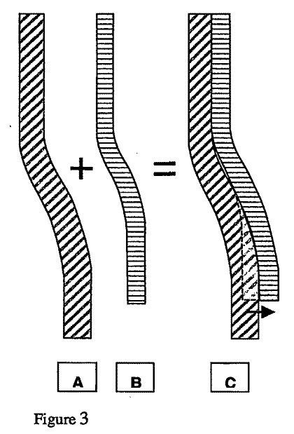

FIG. 3 shows a sketch illustrating another principle according to the present invention of obtaining residual compressive stresses on the interface between tubular sections inside one another, from which sealing is accomplished,

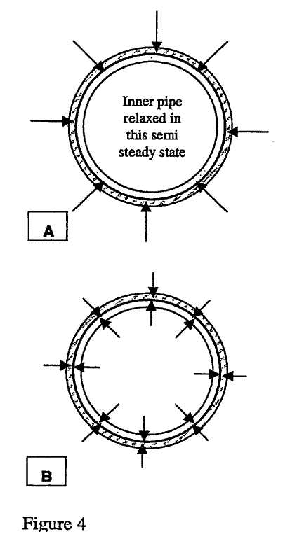

FIG. 4 shows a sketch illustrating a third principle according to the present invention of obtaining residual compressive stresses on the interface between tubular sections inside one another, from which sealing is accomplished,

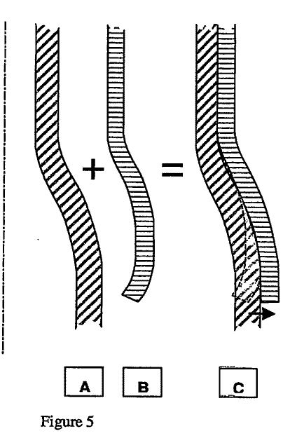

FIG. 5 shows a sketch illustrating a fourth principle according to the present invention of obtaining residual compressive stresses on the interface between tubular sections inside one another, from which sealing is accomplished,

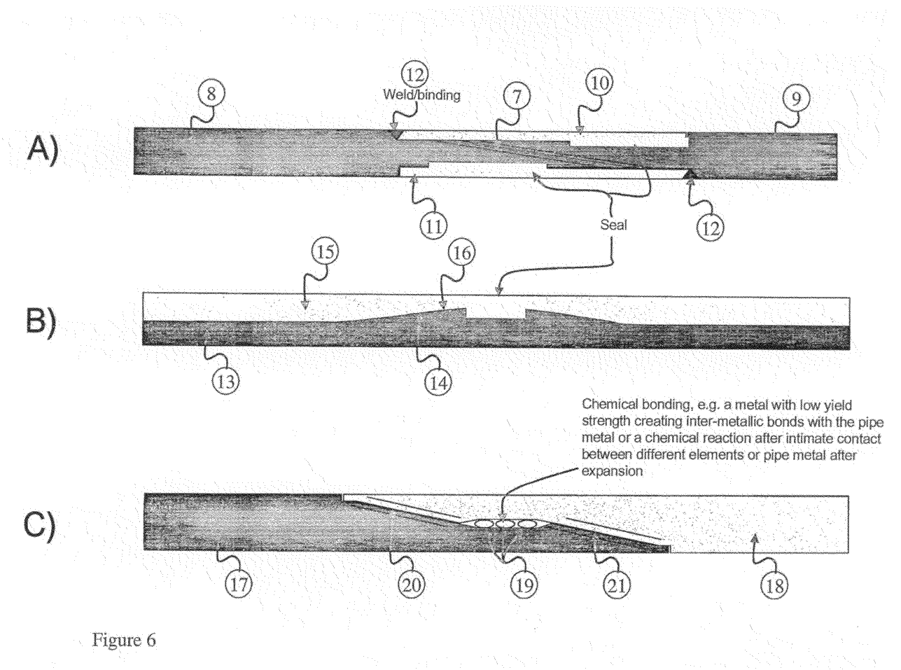

FIG. 6 shows in cross section three examples of connections based on the principles according to the invention.

The present invention is based on the general principle that the pipes or casings are formed from at least two, one outer and one inner tubular section. The ends of each of said respective tubular section is overlapping the next, succeeding tubular section, whereby one or more of the inner, intermediate or outer tubular sections are of different metallic materials and/or different thickness, and under the deformation process, is plastified or plastically deformed in the overlapping zone forming a metallic seal in such zone and thereby providing gas pressure integrity between the inside and outside of the expanded tubular pipe/casing.

FIG. 1 shows an example of a tubular connection according to the invention. More specifically FIG. 1 a) shows, in perspective, a tubular body in the form of a pipe casing, and FIG. 1 b) a cross section of a part of the tubular body along section line A-A in FIG. 1a). In order to maintain gas pressure integrity after expansion, the tubular casing is composed of 2 or more pipes 1, 2, 3, inside one another over the connection, each one with its own connection. The different pipes, and therefore also the connections 4, 5, 6, are axially displaced relative to one another. The metal to metal overlap between the connections, pressed against each other by the residual stress, will form the seal post expansion. The same principle applies if only the connection area are sectioned with multiple tubulars over the wall thickness, while the bulk of the casing remains like conventional casing; one solid wall over the entire wall thickness.

The Invention will obtain a satisfactory gas pressure integrity for production loads in an expandable tubular connection after being exposed to an expansion process, thereby removing the present restriction in application, i.e. application as a production casing, seen in expandable tubular technology.

The connections 4, 5, 6 for each pipe is based on conical, or straight treads. While most treads in conventional casing connections are made out of one continuous tread forming one tread area over the entire wall thickness of the tubular, this technology may enable splitting of the treaded area in two or more treads over the wall thickness of the casing. Each treaded area is positioned an axial distance, δ, from the adjacent connections. The overlapping area, δ, between two adjacent treads, represents the post expansion seal partly or fully. The sealing capacity of the overlapping area, δ, at any time is directly linked to the residual stresses between two overlapping surfaces superposed the operational stresses induced to the same surfaces during operation. Both external and internal overpressure will increase this sealing stress.

The residual stresses are generated through the expansion process by for instance a conical expansion tool (e.g. cone or roller). Two main deformation modes interact: Tension in the θ-direction and bending in the r-z plane. Bending is energised by the cone. Initially, as the cone meets the pipe, the straight pipe is bent outwards as can be seen in FIG. 2 A, dashed body. Since the pipe is a continuous round body around the perimeter, this bending will meet resistance from the membrane stresses and will be pulled back towards the original straight state, though with a larger pipe diameter as can be seen in FIG. 2 A. full body. If the pipe wall once again meets the cone, this process will repeat. If the pipe wall does not meet the cone, the final shape has been reached.

The residual stress can be obtained if the pipe bent outwards meets a barrier before the pipe itself redirect the wall into straight orientation. In such case the barrier will apply a force to the bent pipe wall, which will redirect the pipe into a straight orientation as is shown FIG. 2 B. The elasto-plastic deformation resulting from the force induced by the barrier, will create a spring back force (elastic relaxation stress/strain), referred to herein as residual stresses. These stresses will form the initial sealing force. The barrier in this case is a pipe with larger diameter outside the deforming pipe in question.

The residual stress can also be obtained by a different relative stiffness between adjacent tubular sections. Such stiffness variation can be effectuated by differences between the two bodies, such as different wall thickness or mechanical strength. With different stiffness in the two bodies, the resulting radii of an induced bending by e.g. a cone will be different as is shown in FIGS. 3 A and B. If the body with the smallest bending radius is the outer tubular section, there will be an interaction between the two bodies before the membrane stresses have pulled the pipes straight. The result will be a residual stress between the two tubular sections.

Residual stresses in the interface between two adjacent tubular sections inside one another after an expansion can also come about using different base material properties (rheology) in the tubular sections. To achieve residual interfacial stress in this manner the outer tubular sections must have a higher yield stress than the inner pipe in the state of relaxation. In this way the elastic spring-back of the outer tubular section is longer than the inner tubular section. At one point the inner tubular section is relaxed while the outer tubular continues to retract as is shown in FIG. 4. From here, the system will go into equilibrium by the inner tube retracted to compression, oppositely balanced by some remaining tension in the outer tube. This induces the sealing stress between the tubular sections.

Residual stresses can be generated by the special shape occurring in the two ends of a pipe expanded by a conical device. The effects taking place in the ends are the end-tips bending towards the centre line as can be seen in FIG. 5 B. This effect comes as a result of the interaction between the stiffness of the bend in the pipe as it leaves the cone, and the forces pulling the pipe straight after having left the cone. The force pulling the pipe straight is the adjacent pipe material. In the case of the ends, no material is left to pull the end straight in one of the directions. The result is a residual bending after the pipe has left the cone. Residual stresses can be generated if the bent segment of a pipe meets a straight pipe segment inside itself forcing the inwards bending into more straight shape as is shown in FIG. 5 C.

The invention as defined in the attached claims are not limited to the examples as described above. Thus, the tubular connection may as shown in FIG. 6, example denoted A), consist of tubular sections 8, 9 connected by conical, female respectively male treaded sections and where outer and inner “pipe sections” are in the form of outer and inner rings or bushings 10, respectively 11 are provided around a connected, treaded section 7. The bushings 10, 11, stretching over and lengthwise beyond the threaded section, is preferably connected to the inner tubular body at one end by means of welds 12 to keep the bushing in place under the expansion operation. The outer bushing has reduced thickness compared to the inner tubular section to obtain residual stress as described above. In the example shown in FIG. 6, A) the rings or bushings 10, 11 are provided in recesses in the pipe sections 8, 9. This is not a requirement as they may be provided completely on the inside or outside of the pipe sections, without such recesses.

Further, as shown in FIG. 6, example denoted B), the connection may consist of an inner tubular section 13 with a radially protruding, rounded party 14 having a larger diameter and extending into an outer tubular section 15 with a corresponding inwardly extending, rounded party 16 with larger diameter. The residual stress is in this example obtained, as in example A) above, by the different relative stiffness between the adjacent tubular sections 13, 15 due to different wall thickness for the outer and inner tubular sections.

The residual stress can optionally be enforced by introducing a more formable metal 19 in-between two adjacent tubular sections 17, 18 as shown in FIG. 6, example denoted C), enhancing the metal to metal sealing capacity of the connection. The formable metal 19 may be provided between treaded sections 20, 21 as shown in the figure and can act as:
i) separator between the two tubular sections to enhance the effect described above,
ii) chemical interfacial bounding energised by metal flow during the expansion process, causing oxide film breakage and nascent metal to metal contact,
iii) a metal “gasket” component filling all available space.

The API demand for metal to metal sealing in gas tight connections limits the “gasket” material to metals. Pure aluminium is such a metal, which is highly formable and establish good chemical bonding with steel when pressure and deformation causes the oxide films to break, and intimate steel to aluminium contact is made.

Another material is silver, which has excellent corrosion resistance in intimate contact with steel.

An alternative would also be a chemical bonding, e.g. a metal with low yield strength creating inter-metallic bonds with the pipe metal or a chemical reaction after intimate contact (and possibly raised temperature/pressure) between different elements (reactants) or pipe metal after expansion.

Steel is by far the most commonly used material for casing applications today. The base casing and the connections for this technology can be the standard API 5CT L80 or X80 widely used for conventional casing. Alternatively one could use a material with a higher elongation to accomplish a higher margin to failure by rupturing through the expansion process.

As described above sealing may be energised by different mechanical properties.

In combination with standard L80 casing, a material with higher yield stress outside the L80 would be needed, or a material with a lower yield stress inside L80.

1-5. (canceled)

6. Gas tight tubular connection, particularly related to mono diameter tubular body in the form of a pipe or casing being used in connection with the production of oil and/or gas, where the pipes or casings are manufactured from tubular sections and where the tubular sections, after being interconnected at their respective ends, are finally formed by expansion, wherein the pipes or casings are formed from at least two, one outer and one inner tubular section, the ends of each of which respective section is overlapping the next, succeeding tubular section, whereby one or more of the inner, intermediate or outer tubular sections are of different thickness, and under the deformation process, is plastified or plastically deformed in the overlapping zone, in which the thickness of the inner tubular section is larger than the at least one outer tubular section, resulting in the formation of a metallic seal between the tubular sections due to the induced residual stress, and thereby providing gas pressure integrity between the inside and outside of the expanded tubular pipe/casing.

7. Gas tight tubular connection according to claim 6, wherein the connection includes one inner tubular body (8) where the tubular sections (9), (10) are connected by conical, female respectively male threaded sections, and where an outer ring or bushing (11) is provided around the connected, threaded section, whereby the bushing (11), stretching over and lengthwise beyond the threaded section, is preferably connected to the inner tubular body at one end by means of a weld (12) to keep the bushing in place under the expansion operation, and where the outer bushing has reduced thickness compared to the inner tubular section to obtain residual stress.

8. Gas tight tubular connection according to claim 6, wherein the connection consists of an inner tubular section (13) with a radially protruding, preferably rounded party (14) having a larger diameter than the outer diameter of the inner tubular section and extending into an outer tubular section (15) with a corresponding outwardly extending, rounded party (16) having a larger diameter than the inner diameter of the tubular section.

9. Gas tight tubular connection according to claim 6, wherein formable material, preferably metal (19), is provided in-between two adjacent tubular sections (17,18), whereby the formable material is provided between threaded sections (20,21) of each of the connections between the adjacent sections (17,18).

10. Gas tight tubular connection according to claim 6, wherein the tubular casing is composed of three or more pipes (1,2,3) inside one another over the connection, each one with its own connection, whereby the different pipes and the connections (4,5,6) are axially displaced relative to one another with a distance 8.

11. Gas tight tubular connection according to claim 6, wherein additional residual stresses are generated in the interface between an inner straight tubular body and at least one of the two ends of an outer tubular body, the additional residual stresses being generated by a residual bending in the at least one of the two ends of the tubular body due to the reduced amount of material near the ends compared to positions distant from the ends.
